(19) United States
(12) Patent Application Publication
(10) Pub. No.: US 2015/0325361 A1
(43) Pub. Date: Nov. 12, 2015

(54) Winding Arrangement for Inductive Components and Method for Manufacturing a Winding Arrangement for Inductive Components

(71) Applicant: Franc Zajc, (US)

(72) Inventor: Franc Zajc, Komenda (SI)

(21) Appl. No.: 14/647,066

(22) PCT Filed: Nov. 26, 2012
(86) PCT No.: PCT/EP2012/073650

§ 371 Date: May 22, 2015

(51) Int. Cl. H01F 27/28; H01F 27/29; H01F 41/06; H01F 27/24

(52) U.S. Cl. CPC H01F 27/2823; H01F 27/24; H01F 27/29; H01F 41/0612

(57) ABSTRACT

A winding arrangement for inductive components includes a first winding section comprising at least one first winding, the at least one first winding comprising at least two electrically isolated parallel flat band conductors being configured as a first flat band stack, a second winding section comprising at least one second winding, the at least one second winding comprising at least two electrically isolated parallel flat band conductors being configured as a second flat band stack. The first ends of the flat band conductors of the first winding section are cross connected in a cross connection to first ends of the flat band conductors of the second winding section such that a first current flow stacking sequence in the first flat band stack is reversed to a second current flow stacking sequence in the second flat band stack.

### TECHNICAL FIELD

The invention relates to a winding arrangement for inductive components and a method for manufacturing a winding arrangement for inductive components.

### BACKGROUND

Although applicable to any inductor component, the present invention will be described in combination with inductive components with a high fill factor.

In modern electric and electronic devices winding arrangements for inductive components are an important component. Inductors are especially used in power conversion devices like buck converters and boost converters.

In order to reduce the size of such power conversion devices the working frequencies of said devices become higher. For small power converters up to 10V the working frequencies have risen into the MHz range. For middle sized power converters up to 200V and high power converters up to 500V the target frequency is about 300 kHz to 1 MHz.

In such power conversion devices the inductive components (inductors or transformers) are an important factor regarding losses and size. Particularly, the size of the inductive components should be as small as possible, the shape should be square and the AC/DC resistance ratio should be as low as possible at the desired working frequency.

Common inductive elements—like shown in FIG. 16 comprise a toroidal core TC with a litz or strand wire SW wound around the core TC. Inductors like the one shown in FIG. 16 have a favorable AC/DC current ratio, but such conductors are relatively big and the fill factor is small, especially when additional isolation is required in order to implement secondary windings in transformer applications. Furthermore, the shape of such inductive components is inconvenient to use in modern power conversion devices.

With the constant increase of the working frequency of such power conversion devices the so called “skin effect” becomes more and more relevant when designing power conversion devices. The skin effect is responsible for the current being conducted in a skin area of the conductor, wherein the skin depth δ becomes smaller with higher frequencies. The skin depth δ is about 0.1 mm or less for frequencies in the MHz area. Therefore, the thickness of the conductors of such common inductive elements like the one shown in FIG. 13 is limited to 0.2 mm (2δ). Consequently, the increase of the working frequency results in thinner conductors. The thinner the conductors with round intersection are, the higher the number of litz wires in the litz or strand wire needs to be to conduct the load current. A high number of litz wires results in an even worse fill factor of such inductors.

Inductors can also comprise flat band conductors instead of litz wires. Such inductors are shown in FIGS. 13 and 14, respectively.

FIG. 13 shows an inductor with a magnetic core 1″″, wherein the magnetic core 1″″ has two winding windows 2a″″ and 2b″″. FIG. 13 also shows the flux lines that build up in such an inductor.

A certain percentage of flux lines inevitably passes the winding windows 2a″″ and 2b″″, which effects that not all of the winding turns N1, N2 include the same flux causing differences in induced voltage in individual turns. Specifically, as seen in FIG. 13, the core flux Φ surrounds the winding windows 2a″″ and 2b″″, while the stressed flux line Φ″ passes the winding windows 2a″″ and 2b″″. The turn N₁ includes Φ₁ flux lines, while the turn N₂ includes Φ₂ flux lines. The flux Φ₁ includes complete core flux Φ′ and a part of stressed flux Φ″ that is represented by Φ₁″, while the flux Φ₂ includes the complete core flux Φ′ and a part of the stressed flux Φ″ that is represented by Φ₁″ and Φ₂″. Since the stressed flux Φ₂ is greater than the stressed flux Φ₁, and the changes of flux over time are increased as more flux lines are included and the induced voltage in the turn N₂ is greater than in turn N₁.

In the case of all the winding turns N1, N2 being connected in series, as it is commonly used for the windings of inductive components, the difference in the induced voltage of the winding turns in different positions in the winding windows 2a″″ and 2b″″ has no negative effect, because the induced voltages of all winding turns N1, N2 are summed up and therefore cause no equalizing currents.

In order to reduce the ohmic losses caused due to high frequency current, the demand for thinning the conductor thickness increases drastically. The thickness thinning of the conductors with round intersection results in increase of the number of litzes in the strand in order to be able to conduct the load current. The thinner the litz wires are the worse the fill-factor of such winding is. Thinning the square intersection flat conductors limits the maximum possible load current. The load current can be increased by the expansion of the winding window, which is possible only to certain limits set due to the outside inductor dimension ratio. Division of the individual flat conductor strips into more strips is not possible, since interleaving, which is normally used in litz strand conductors cannot be achieved.

However, the flat wires do achieve a much better fill factor than litz wires, since they present an advantage in the possibility of compensating the thinning of the conductors by increasing the width of individual conductors. The simultaneous increase of the length of the winding windows 2a″″ and 2b″″ is possible only within certain limits, therefore in such multi-layer windings single flat band conductors connected in parallel to form a single winding presents a possible solution.

Despite the equalizing currents in litz or strand wires being negligible the fill factor deteriorates the high frequency operation for high currents applications, since with the frequency increase the isolator/conductor ratio raises.

Besides the voltage change occurring due to the different position of the winding turns N1, N2 in the winding windows 2a″″ and 2b″″ there are also other aspects that deteriorate the high frequency operation for high current applications. The load current of individual winding turns N1, N2 influences the current in all of the other turns of the same winding by creating its own magnetic field causing longitudinal circular current flowing on the inner and outer side of the individual conductor with respect to the core. These longitudinal circular currents are summed up with the load current, such that the load current is increased on the inner side of the conductor and decreased on the outer side of the conductor, this phenomena is called proximity effect. The consequence of the proximity effect are greater ohmic losses with the increase of frequency.

Using flat band conductors in parallel solves the skin and proximity effect, while simultaneously allowing the same load current to flow through the winding as the effective conductive area remains the same. Specifically, FIG. 14 shows a magnetic core 1′″ with a winding with a single conductor which is divided into two parallel flat band strips S₁″ and S₂″ isolated between each other and surrounding the gap G_{W}″. The parallel flat band strips S₁″ and S₂″ are short circuited in connection areas 3 providing taps T₁ and T₂ to form a single conductor is demonstrated in FIG. 14.

Dividing individual conductors into flat band strips solves the fill factor, skin effect and proximity effect issue at the same time. The flux leakage into the area of the winding windows 2a″″ and 2b″″ cannot be removed. The flux tends to flow through low permeability areas such as isolator or air in the winding window area and partly through the conductors. The gap G_{W}″ between both parallel conductor strips S₁″ and S₂″ presents an area for the flux lines Φ_{W} to penetrate into it resulting in a voltage difference ΔV among individual parallel conductor strips S₁″ and S₂″ of the same conductor.

Therefore, an additional voltage causing longitudinal current I_{WL} through parallel conductor strips S₁″ and S₂″ and both connection taps T₁″″, T₂″″ appears, as demonstrated in FIG. 15. In FIG. 15 a winding W″ is shown, with two parallel conductor strips S₁″ and S₂″ and the gap G_{W}″ between the parallel conductor strips S₁″ and S₂″, wherein the flux Φ_{G} penetrates the gap G_{W}″. This voltage equalizing longitudinal current I_{WL} is added to the load current as the summation of both contributions. The induced longitudinal current I_{WL} is a problem in paralleled conductor strips which is similar to the problems caused by the proximity effect.

Document WO 2007/136288A1 shows a method for winding a high-frequency transformer by winding a strip of electrically conductive material around a core in two parallel windings.

### SUMMARY

This problem is solved by the features of the independent claims.

Accordingly, the present patent application provides:
A winding arrangement for inductive components, comprising a first winding section comprising at least one first winding, the at least one first winding comprising at least two electrically isolated parallel flat band conductors being configured as a first flat band stack, a second winding section comprising at least one second winding, the at least one second winding comprising at least two electrically isolated parallel flat band conductors being configured as a second flat band stack, wherein first ends of the flat band conductors of the first winding section are cross connected in a cross connection to first ends of the flat band conductors of the second winding section such that a first current flow stacking sequence in the first flat band stack is reversed to a second current flow stacking sequence in the second flat band stack, wherein second ends of the flat band conductors of the first winding section are at least electrically connected in a first electric tap, and wherein second ends of the flat band conductors of the second winding section are at least electrically connected in a second electric tap.
An electric transformer, comprising at least one winding arrangement for inductive components according to the invention.
A method for manufacturing a winding arrangement for inductive components, comprising the steps of providing a first winding section comprising at least one first winding, the at least one first winding comprising at least two electrically isolated parallel flat band conductors, the first winding being configured as flat band stack, providing a second winding section comprising at least one second winding, the at least one second winding comprising at least two electrically isolated parallel flat band conductors, the second winding being configured as flat band stack, winding the at least one first winding, winding the at least one second winding, and cross connecting the flat band conductors of the first winding section to the flat band conductors of the second winding section such that a first current flow stacking sequence in the first flat band stack is reversed to a second current flow stacking sequence in the second flat band stack, connecting second ends of the flat band conductors of the first winding section at least electrically in a first electric tap, and connecting second ends of the flat band conductors of the second winding section at least electrically in a second electric tap.

The present invention is based on the idea that the longitudinal current through parallel conductor strips should be eliminated to improve the efficiency of an inductor.

Therefore, the present invention provides a winding arrangement for inductive components where the winding of the inductor is divided into two separate winding sections. Furthermore, the single winding section each comprises at least one winding, which is formed of a flat band stack of flat band conductors.

In order to effectively remove the longitudinal current through parallel conductor strips the connection between the first flat band stack of the first winding section and the second flat band stack of the second winding section is arranged as a cross connection. Furthermore, the first flat band stack forms a first winding which is wound in a first direction and the second flat band stack forms a second winding, which is wound in a second direction which is opposite to the first direction.

Concerning the present patent application “cross connection” means that the flat band conductors of the first winding section are connected to the flat band conductors of the second winding section in reversed order. That means the first flat band conductor of the first winding section is connected to the last flat band conductor of the second winding section, the second flat band conductor of the first winding section is connected to the second to last flat band conductor of the second winding section, and so forth. Therefore a first current flow stacking sequence in the first flat band stack is reversed compared to a second current flow stacking sequence in the second flat band stack.

Finally, the ends of the flat band conductors which exit the first winding section and the second winding section, respectively, are electrically connected together in each case to form electrical taps, which are used to electrically interface the inductor.

The cross connection according to the present invention greatly reduces longitudinal currents in parallel flat band conductors. Thus, the flat conductor strips can be used and the effective intersection area of the winding window is increased and the DC/AC resistance ratio is reduced. The parallel arrangement of the flat band strips in each individual winding allows the intersection to be adapted to different winding window shapes. Furthermore, the parallel arrangement of the flat band conductors allows narrowing of the strips and, therefore, lowers the parasitic capacitance of the windings.

Finally, the ohmic losses are reduced in an inductor according to the present invention. Consequently, further frequency increases with simultaneous reductions in size become possible.

Further embodiments of the present invention are subject of the dependent claims and of the following description, referring to the drawings.

In one embodiment the at least one first winding is wound in a first winding direction with regard to a virtual axis of the winding arrangement for inductive components and the at least one second winding is wound in a second winding direction being opposite to the first winding direction with regard to the virtual axis of the winding arrangement for inductive components.

In a preferred embodiment of the winding arrangement for inductive components at least one first winding is wound on a first magnetic core and at least one second winding is wound around a second magnetic core.

In a preferred embodiment the stacking sequence is reversed through the at least one first winding and the at least one second winding being wound around the first magnetic core and the second magnetic core, respectively, in an s-shaped arrangement. This allows providing a reverse current flow stacking sequence in the first winding section compared to the second winding section without, the need to explicitly provide a cross section, because the cross section is implicitly formed by the s-shaped arrangement.

In a preferred embodiment the winding arrangement for inductive components comprises a magnetic core, the first winding section including the at least one first winding being wound around the core in the first winding direction and the second winding section including the at least one second winding being wound around the core in the second winding direction connected between each other with the cross-connection. Using a magnetic core further improves the inductivity of the winding arrangement for inductive components according to the present invention.

In a preferred embodiment the first winding section and the second winding section are configured essentially symmetrical. If the first winding section and the second winding section are configured essentially symmetrical the longitudinal currents in parallel flat band conductors are optimally reduced.

In the context of the present patent application the term “symmetrical” does not necessarily refer to a mechanical or geometrical symmetry. Rather, the term symmetrical can also refer to electrically symmetry. This means that in both winding sections the same electrical voltage is induced or that both winding sections circumvent the same amount of magnetic flux between the individual parallel conductive flat bands.

In a preferred embodiment the first winding section comprises at least two first windings, the electrical conductors of the at least two first windings being connected electrically in series in a direct connection and the at least two first windings being wound in alternating directions.

In a preferred embodiment the second winding section comprises at least two second windings, the electrical conductors of the at least two second windings being connected electrically in series in a direct connection and the at least two second windings being wound in alternating directions.

Providing the first winding section and the second winding section with a plurality of windings allows further reducing the capacitance of the winding sections.

In a preferred embodiment the cross connection is arranged at the innermost loop of the at least one first winding and the at least one second winding. This allows integrating the cross connection into the inductor and building a very compact inductor.

In a preferred embodiment the cross connection is arranged at the outermost loop of the at least one first winding and the at least one second winding. On the outer region of the windings there is more space available for the cross connection. Therefore, easy construction and assembly of the winding arrangement for inductive components becomes possible.

In a preferred embodiment the cross connection is implemented by an electric wiring arrangement. This allows providing a very simple cross connection.

In a preferred embodiment the cross connection is implemented by a folding arrangement of the at least one first winding section and/or the at least one second winding section. This allows providing a very compact cross connection which can be embedded deeply in the winding arrangement for inductive components without the need to establish the cross connection using e.g. soldering tools.

In a preferred embodiment the first winding section and the second winding section with the cross connection in between are implemented by a folding arrangement of one single longitudinal flat band stack. This allows providing a very simple and, therefore, cost effective arrangement for the windings of the winding arrangement for inductive components.

In a preferred embodiment the first winding section and the second winding section with the cross connection in between are implemented by a folding arrangement of one u-shaped flat band stack, the first winding section being formed by a first arm of the u-shaped flat band stack, the second winding section being formed by a second arm of the u-shaped flat band stack, and the cross section being formed by a connection element of the u-shaped flat band stack, which connection element connects the first arm and the second arm of the u-shaped flat band stack. This allows providing a very compact cross connection.

### BRIEF DESCRIPTION OF THE DRAWINGS

For a more complete understanding of the present invention and advantages thereof, reference is now made to the following description taken in conjunction with the accompanying drawings. The invention is explained in more detail below using exemplary embodiments which are specified in the schematic figures of the drawings, in which:

FIG. 1 shows a block diagram of a first embodiment of a winding arrangement for inductive components according to the present invention;

FIG. 2 is a block diagram of a second embodiment of a winding arrangement for inductive components according to the present invention;

FIG. 3 is a block diagram of a third embodiment of a winding arrangement for inductive components according to the present invention;

FIG. 4 is a schematic presentation of a fourth embodiment of a winding arrangement for inductive components according to the present invention, where stretched first and second windings with a cross connection are shown in detail;

FIG. 5 is a schematic presentation of a fifth embodiment of a winding arrangement for inductive components according to the present invention, where two stretched first windings with a direct connection are shown in detail;

FIG. 6 shows a vertical cross section of a sixth embodiment of a winding arrangement for inductive components according to the present invention;

FIG. 7 shows a vertical cross section of a seventh embodiment of a winding arrangement for inductive components according to the present invention;

FIG. 8 is a top view of an eighth embodiment of a winding arrangement for inductive components according to the present invention, where a flat band stack is shown in detail;

FIG. 8a,b,c,d are perspective views of the flat band stack of the eighth embodiment shown in FIG. 8 in various winding steps;

FIG. 9 is a top view of a ninth embodiment of a winding arrangement for inductive components according to the present invention, where a flat band stack is shown in detail;

FIG. 9a,b,c are perspective views of the flat band stack of the ninth embodiment of the winding arrangement for inductive components shown in FIG. 9 in various winding steps;

FIG. 10 is a top view of a tenth embodiment of a winding arrangement for inductive components according to the present invention, where a flat band stack is shown in detail;

FIG. 10a,b are perspective views of the flat band stack of the tenth embodiment of the winding arrangement for inductive components shown in FIG. 10 in various winding steps;

FIG. 11 is a top view of an eleventh embodiment of a winding arrangement for inductive components according to the present invention, where a flat band stack is shown in detail;

FIG. 11a,b,c are perspective views of the flat band stack of the eleventh embodiment of the winding arrangement for inductive components shown in FIG. 11 in various winding steps;

FIG. 12 is an intersection of a planar version of a twelfth embodiment of a winding arrangement for inductive components according to the present invention;

FIG. 13 shows a vertical cross section of an inductive component in order to demonstrate flux lines;

FIG. 14 shows a horizontal cross section of an inductive component of FIG. 13;

FIG. 15 is a stretched conductor of the inductive component of FIG. 13;

FIG. 16 shows an exemplary inductor.

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily drawn to scale relative to each other. Like reference numerals designate corresponding similar parts.

### DETAILED DESCRIPTION OF THE DRAWINGS

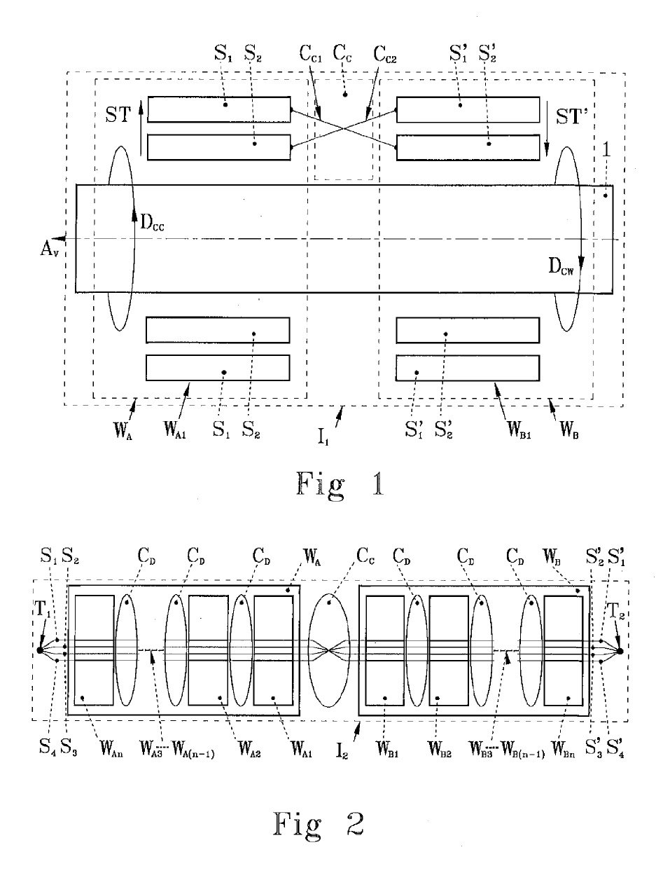

FIG. 1 shows a block diagram of a first embodiment of a winding arrangement for inductive components I1 according to the present invention.

The winding arrangement for inductive components I1 of FIG. 1 comprises a magnetic core 1 which lies in a virtual axis A_{V} of the winding arrangement for inductive components I1, a first winding section W_{A} and a second winding section W_{B}. The first winding section W_{A} comprises one first winding W_{A1} which is wound from the top of the magnetic core 1 around the back of the magnetic core 1 to the bottom of the magnetic core 1 in a first winding direction D_{CC}. The second winding section W_{B} comprises one second winding W_{B1} which is wound from the top of the magnetic core 1 around the front of the magnetic core 1 to the bottom of the magnetic core 1 in a second winding direction D_{CW}.

The first winding W_{A1} comprises two flat band conductors S₁, S₂ being configured as a first flat band stack ST.

The second winding W_{B1} also comprises two flat band conductors S₁′, S₂′ being configured as a second flat band stack ST′.

Finally first ends of the flat band conductors S₁, S₂ and S₁′, S₂′ are cross connected in a cross connection C_{C}, C_{C1}-C_{C2} such that a first current flow stacking sequence in the first flat band stack ST is reversed to a second current flow stacking sequence in the second flat band stack ST′. Precisely, flat band conductor S₁ is connected to flat band conductor S₂′ and flat band conductor S₂ is connected to flat band conductor S₁′.

FIG. 2 is a block diagram of a second embodiment of a winding arrangement for inductive components I2 according to the present invention.

The winding arrangement for inductive components I2 comprises a first winding section W_{A} and a second winding section W_{B}. The first winding section W_{A} comprises a plurality of first windings W_{A1}-W_{An}, wherein only three of the first windings W_{A1}, W_{A2} and W_{An} are displayed. The second winding section W_{B} comprises a plurality of second windings W_{B1}-W_{Bn}, wherein only three of the second windings W_{B1}, W_{B2} and W_{Bn} are displayed. The first windings W_{A1}-W_{An}, and the second windings W_{B1}-W_{Bn}, respectively, are connected in series with a direct connection C_{D} in each case. The position of the direct connection C_{D} alternates between

Between the first winding section W_{A} and the second winding section W_{B} the innermost windings W_{A1} and W_{B1} are cross connected in a cross connection C_{C}.

Finally, the ends of the flat band connectors S₁-S₄ of the first winding section W_{A} are electrically connected together in a first tap T₁ and the ends of the flat band connectors S₁′-S₄′ of the second winding section W_{B} are electrically connected together in a first tap T₂.

In FIG. 2 a plurality of possible first windings W_{A3}-W_{A(n-1)} and a plurality of possible second windings W_{B3}-W_{B(n-1)} are suggested by a dotted line. Therefore, the winding arrangement for inductive components of FIG. 2 could have an arbitrary number of first windings W_{A1}-W_{An} and second windings W_{B1}-W_{Bn}.

In FIG. 2 the first winding section W_{A}, the second winding section W_{B}, the first windings W_{A1}-W_{An} and the second windings W_{B1}-W_{Bn} are displayed as rectangular boxes for illustration purpose.

FIG. 3 is a block diagram of a third embodiment of a winding arrangement for inductive components I3 according to the present invention.

The winding arrangement for inductive components I3 of FIG. 3 differs from the winding arrangement for inductive components I3 of FIG. 2 in that the first windings W_{A1}-W_{An} and the second windings W_{B1}-W_{Bn} are displayed as windings comprising two flat band conductors each.

In FIG. 3 as in FIG. 2 the first winding section W_{A} comprises a plurality of first windings W_{A1}-W_{An} wherein only three of the first windings W_{A1}, W_{A2} and W_{An} are displayed. The second winding section W_{B} comprises a plurality of second windings W_{B1}-W_{Bn}, wherein only three of the second windings W_{B1}, W_{B2} and W_{Bn} are displayed. A plurality of possible first windings W_{A3}-W_{A(n-1)} and a plurality of possible second windings W_{B3}-W_{B(n-1)} are suggested by a dotted line. Therefore, the winding arrangement for inductive components of FIG. 3 could have an arbitrary number of first windings W_{A1}-W_{An} and second windings W_{B1}-W_{Bn}.

In FIG. 3 over every one of the first windings W_{A1}-W_{An} and the second windings W_{B1}-W_{Bn} the winding direction is displayed with an arrow. Furthermore the windings are wound around a virtual axis A_{V} of the inductor I3.

The first winding direction D_{CC} in FIG. 3 is defined as a winding starting with the innermost loop on top of a not displayed magnetic core 1, winding in front of the not displayed magnetic core 1 to the bottom of the not displayed magnetic core 1. The second winding direction D_{CW} is opposite to the first winding direction D_{CC}.

In FIG. 3 the first windings W_{A1} and W_{An} and the second winding W_{B2} are wound in the first winding direction D_{CC}.

The first winding W_{A2} and the second windings W_{B1} and W_{Bn} are wound in the second winding direction D_{CW}.

FIG. 3 shows that within a single winding section W_{A} and W_{B} a division into more individual windings W_{A1}-W_{An} and W_{B1}-W_{Bn} is possible. Dividing the winding sections W_{A} and W_{B} into more individual windings W_{A1}-W_{An} and W_{B1}-W_{Bn} reduces the leakage capacity of the windings as the adjacent surface between the turns is reduced due to a reduced flat band conductor strip width. The individual windings W_{A1}-W_{An} form the first winding section W_{A} and the individual windings W_{B1}-W_{Bn} form the second winding section W_{B}. Within each winding section the windings W_{A1}-W_{An} and W_{B1}-B_{Bn} are connected with a direct connection C_{D}, while for the connection between both individual winding sections W_{A} and W_{B} the cross connection C_{C} is necessary.

In one embodiment the number of the individual windings within one winding section is the same for both winding sections W_{A} and W_{B}.

Finally, the ends of the flat band connectors S₁-S2 of the first winding W_{An} are electrically connected together in a first tap T₁ and the ends of the flat band connectors S₁′-S₄′ of the second winding W_{Bn} are electrically connected together in a first tap T₂.

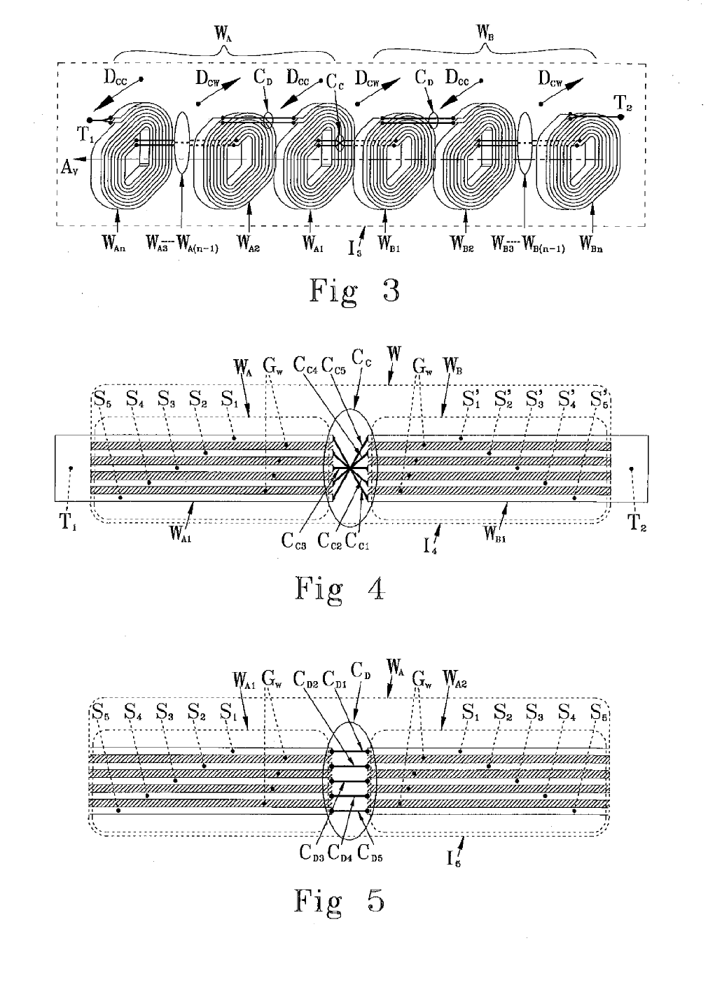

FIG. 4 is a schematic presentation of a fourth embodiment of a winding arrangement for inductive components I4 according to the present invention, where stretched first and second windings W_{A1} and W_{B1} with a cross connection C_{C} are shown in detail.

The windings in FIG. 4 each comprise five flat band conductors S₁-S₅ and S₁′-S₅′. At the outer end of the first winding section W_{A} the ends of the flat band conductors S₁-S₅ are electrically connected together in a first tab T₁. The ends of the flat band conductors S₁′-S₅′ are electrically connected together in a second tab T₂ at the outer end of the second winding section W_{B}. Between the flat band conductors S₁-S₅ and S₁′-S₅′ a gap G is arranged.

In the middle, between the first winding section W_{A} and the second winding section W_{B} the single flat band conductors S₁-S₅ of the first winding section W_{A} and the single flat band conductors S₁′-S₅′ of the second winding section W_{B} are connected to each other in a cross connection C_{C}.

In FIG. 4 there is one cross connection C_{C1}-C_{C5} for every pair of flat band conductors S₁-S₅ and S₁′-S₅′.

The first flat band conductors S₁-S₅ of the first winding section W_{A} are connected to the second flat band conductors S₁′-S₅′ of the second winding section W_{B} in the manner to change the current flow stacking sequence, such that the first flat band conductor S₁ of the first winding section W_{A} is connected to the second flat band conductor S₅′ of the second winding section W_{B}, the first flat band conductor S₂ of the first winding section W_{A} is connected to the second flat band conductor S₄′ of the second winding section W_{B}, and so on. The number of the insulated flat conductor strips is the same for both winding sections W_{A} and W_{B}.

FIG. 5 is a schematic presentation of a fifth embodiment of a winding arrangement for inductive components I5 according to the present invention, where two stretched first windings W_{A1} and W_{A2} with a direct connection C_{D} are shown in detail. The same arrangement is possible for two stretched second windings W_{B1} and W_{B2}.

One direct connection C_{D1}-C_{D5} is provided for every one of the first flat band conductors S₁-S₅. The first flat band conductors S₁-S₅ of the first winding W_{A1} are connected to the first flat band conductors S₁-S₅ of the first winding W_{A2} in the manner to keep the current flow stacking sequence unchanged, such that the first flat band conductor S₁ of the first winding W_{A1} is connected to the first flat band conductors S₁ of the first winding W_{A2}, that the first flat band conductor S₂ of the first winding W_{A1} is connected to the first flat band conductors S₂ of the first winding W_{A2}, and so on. The number of flat band conductors S₁-S₅ is the same for both symmetrical windings. In the embodiment of FIG. 5 the windings W_{A1} and W_{A2} consist of five first flat band conductors S₁-S₅. In other embodiments another number of flat band conductors S₁-S₅ is possible. Between the flat band conductors S₁-S₅ a gap G_{W} is arranged.

FIG. 6 shows a vertical cross section of a sixth embodiment of a winding arrangement for inductive components I6 according to the present invention.

The vertical cross section of a preferred embodiment of the winding arrangement for inductive components I6 according to the present invention shows a magnetic core 1′ with winding windows 2a′ and 2b′. In the winding windows 2a′ and 2b′ are arranged a first winding section W_{A}′ and a second winding section W_{B}′, the first winding section W_{A}′ comprising a first winding W_{A1}′ and the second winding section W_{B}′ comprising a second winding W_{B1}′. Each one, the first winding W_{A1} and the second winding W_{B1} comprises two flat band conductors S₁, S₂ and S₁′, S₂′ and has five turns.

The position of the cross connection C_{C}1, C_{C}2 of the first winding W_{A1} of the first winding section W_{A} with the second winding W_{B1} of the second winding section W_{B} is at the innermost turn of the first winding W_{A1} and the second winding W_{B1}. A magnified version of the cross connection is shown in an enlargement A1.

A cross connection C_{C1} connects the flat band conductor S₁ of the first winding W_{A1} of the first winding section W_{A}′ to the flat band conductors S₂′ of the second winding W_{B1} of the second winding section W_{B}′. Furthermore, a cross connection C_{C2} connects the flat band conductor S₂ of the first winding W_{A1} of the first winding section W_{A}′ to the flat band conductors S₁′ of the second winding W_{B1} of the second winding section W_{B}′. The cross sections are shown in detail in enlargement A1.

For the first winding W_{A1} and the second winding W_{B1} a tap T₁ and a Tap T₂, respectively, are arranged on the outer side of the respective winding W_{A1}, W_{B1} to form convenient contacts of the winding arrangement for inductive components I6.

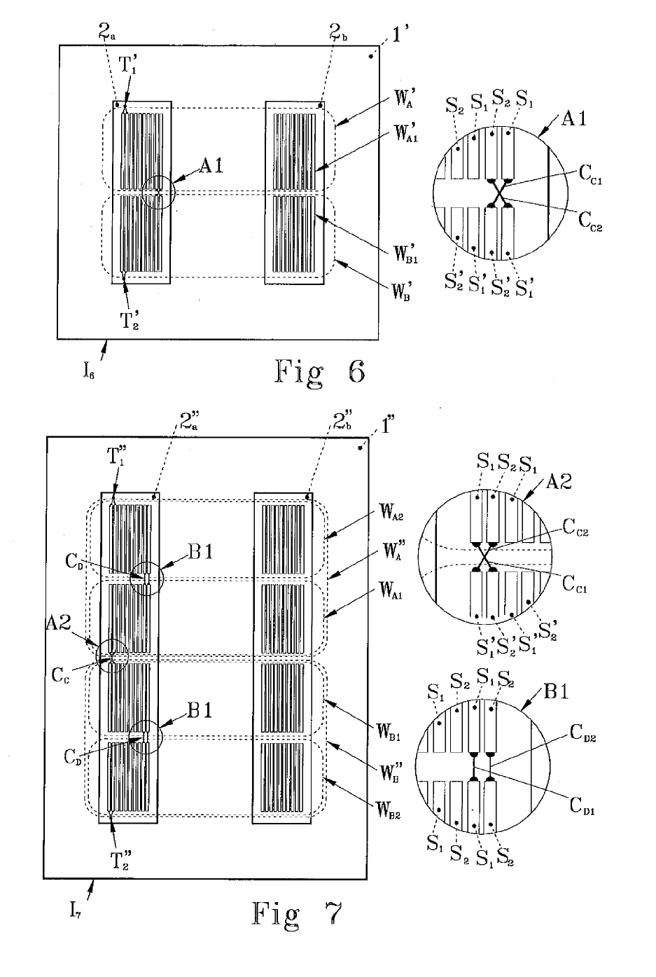

FIG. 7 shows a vertical cross section of a seventh embodiment of a winding arrangement for inductive components I7 according to the present invention.

The vertical cross section of a preferred embodiment of the winding arrangement for inductive components I7 according to the present invention shows a magnetic core 1″ with winding windows 2a″ and 2b″. In the winding windows 2a″ and 2b″ are arranged a first winding section W_{A}″ and a second winding section W_{B}″.

The vertical cross section of a preferred embodiment of the winding arrangement for inductive components I7 according to the present invention differs from the winding arrangement for inductive components I6 of FIG. 6 in that the cross section C_{C} is arranged at the outermost turn of the first winding W_{A1} and the second winding W_{B1}. Furthermore, the first winding section W_{A}″ comprises a first winding W_{A1} and a first winding W_{A2} and the second winding section W_{B}″ comprises a second winding W_{B1} and a second winding W_{B2}.

Between the first winding W_{A1} and the first winding W_{A2} a direct connection C_{D1} connects the flat band conductor S₁ of the winding W_{A1} to the flat band conductor S₁ of the winding W_{A2}. Furthermore, a direct connection C_{D2} connects the flat band conductor S₂ of the winding W_{A1} to the flat band conductor S₂ of the winding W_{A2}. The direct connection is shown in detail in enlargement B1.

Analogous direct connections C_{D1} and C_{D2} are established between the flat band conductor S₁′ of the winding W_{B1} to the flat band conductor S₁′ of the winding W_{B2} and the flat band conductor S₂′ of the winding W_{B1} and the flat band conductor S₂′ of the winding W_{B2}.

A cross connection C_{C1} connects the flat band conductor S₁ of the first winding W_{A1} of the first winding section W_{A}′ to the flat band conductors S₂′ of the second winding W_{B1} of the second winding section W_{B}′. Furthermore, a cross connection C_{C2} connects the flat band conductor S₂ of the first winding W_{A1} of the first winding section W_{A}′ to the flat band conductors S₁′ of the second winding W_{B1} of the second winding section W_{B}′. The cross sections are shown in detail in enlargement A2.

For the first winding W_{A2} and the second winding W_{B2} a tap T₁″ and a Tap T₂″, respectively, are arranged on the outer side of the respective winding W_{A2}, W_{B2} to form convenient contacts of the winding arrangement for inductive components I7.

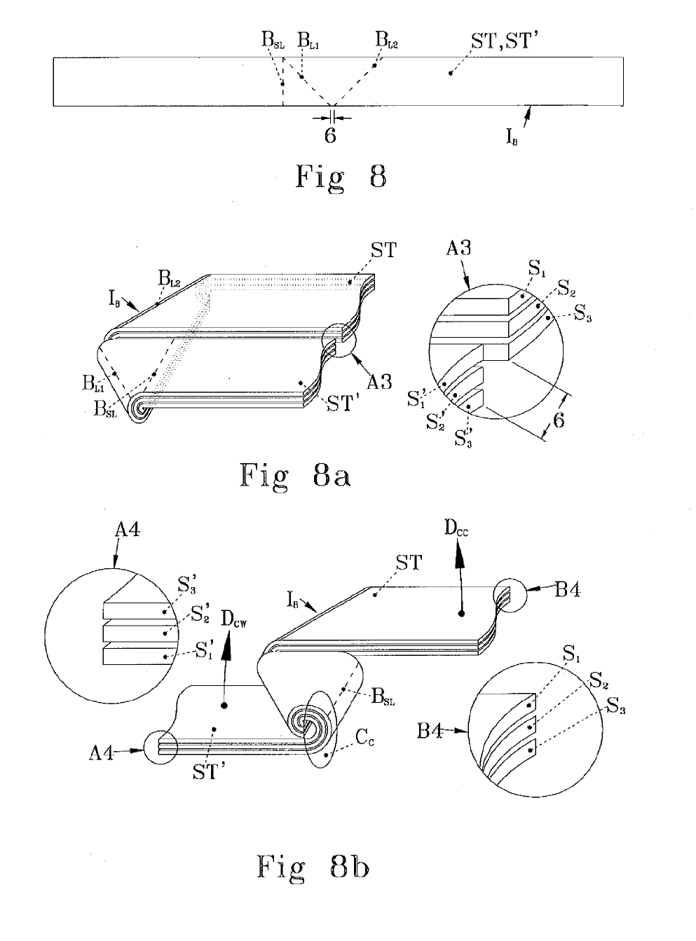

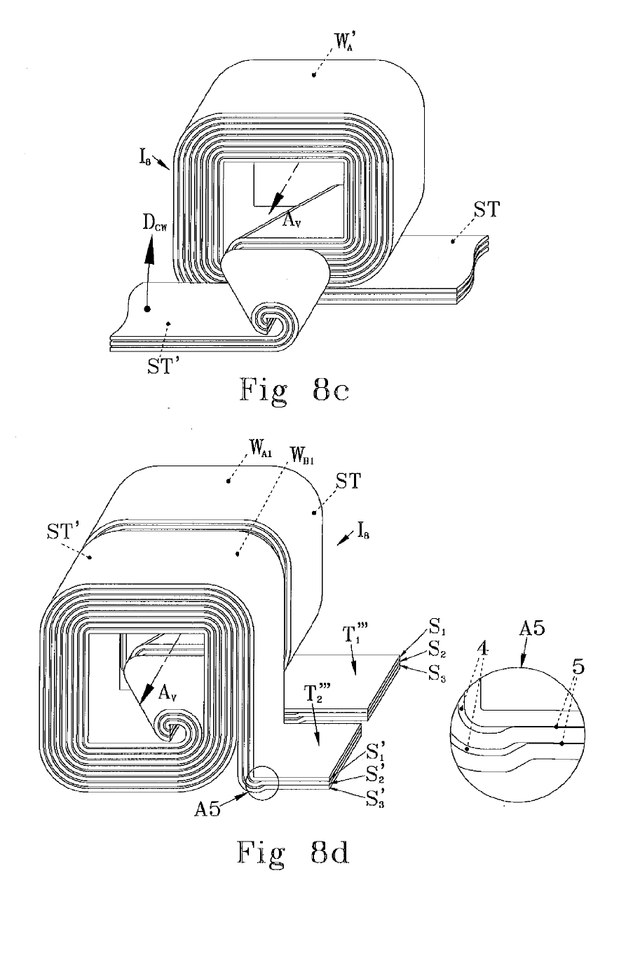

FIG. 8 is a top view of an eighth embodiment of a winding arrangement for inductive components I8 according to the present invention, where a flat band stack ST, ST′ is shown in detail.

The flat band stack ST, ST′ extends longitudinally such that the length of the flat band stack ST, ST′ is larger than the width of the flat band stack ST, ST′.

In FIG. 8 three folding lines B_{L1}, B_{L2} and B_{LS} are indicated on the flat band stack ST, ST′. The first folding line B_{L1} starts at the bottom of the middle of the flat band stack ST, ST′ and runs in a 45° angle to the left of the flat band stack ST, ST′ until reaching the top edge of the flat band stack ST, ST′. Furthermore, the second folding line B_{L2} starts at the bottom of the middle of the flat band stack ST, ST′ and runs in a 45° angle to the right of the flat band stack ST, ST′ until reaching the top edge of the flat band stack ST, ST′. Finally, the third folding line B_{SL} runs from the point, where the first folding line B_{L1} crosses the top edge of the flat band stack ST, ST′ orthogonally to the bottom of the flat band stack ST, ST′.

FIG. 8 a,b,c are perspective views of the flat band stack ST, ST′ of the eighth embodiment shown in FIG. 8 in various winding steps.

The sequence of the FIGS. 8a, 8b, 8c, 8d demonstrates the sequence of the folding procedure. The flat band stack ST, ST′ comprises three flat band conductors S₁, S₂, S₃.

The flat band stack ST, ST′ is bent in the same direction on the folding lines B_{L1} and B_{L2}. The folding along folding lines B_{L1} and B_{L2} of FIG. 8a results in a essentially u-shaped flat band stack ST, ST′. The folding line B_{SL} is indicated on the second flat band stack ST′. This is shown in FIG. 8a. Furthermore, in FIG. 8a an enlargement A3 shows the stacking sequence of the flat band conductors S₁, S₂, S₃ and the flat band conductors S₁′, S₂′, S₃′.

FIG. 8b shows the flat band stack ST, ST′ after bending the flat band stack ST, ST′ at folding line B_{SL}, which inherently results in a reversed current flow stacking sequence and therefore performs the cross connection C_{C}. In FIG. 8b an enlargement A4 shows the stacking sequence of the flat band conductors S₁, S₂, S₃ and an enlargement B4 shows the stacking sequence of the flat band conductors S₁′, S₂′, S₃′. Furthermore, the folding directions D_{CC} and D_{CW}, respectively, are both indicated in the flat band stacks ST and ST′.

The first two foldings in FIG. 8a separate both winding sections W_{A} and W_{B}, but do not change current flow stacking sequence. The current flow stacking sequence of both winding sections W_{A} and W_{B} remains the same, namely S₁, S₂, S₃. The current flow stacking sequence changing is performed by bending over stack bending lines B_{SL} and a perspective view of the complete cross connection C_{C} execution is shown in FIG. 8b, wherein the current flow stacking sequence of the first winding section W_{A} is S₁, S₂, S₃, while the current flow stacking sequence of the second winding section W_{B} is inverted S₃′, S₂′, S₁′.

First winding W_{A1} is wound counterclockwise in the first winding direction D_{CC} as shown in FIG. 8c. Second winding W_{B1} is wound clockwise in the second winding direction D_{CC} as shown in FIG. 8d.

FIG. 8d shows one preferred embodiment of the winding arrangement for inductive components I8. The flat band conductors S₁ to S₃ and S₁′ to S₃′ are electrically isolated by isolator 4. Furthermore, the ends of the flat band conductors S₁ to S₃ and S₁′ to S₃′ are electrically connected in electrical connections 5 and form taps T₁′″ and T₂′″, respectively. Both taps T₁′″ and T₂′″ are on the same outer side of the winding arrangement for inductive components I8. This is shown in enlargement A5.

In all FIGS. 8-8d the windings W_{A1} and W_{B1} are wound around the virtual Axis A_{V} of the winding arrangement for inductive components I8.

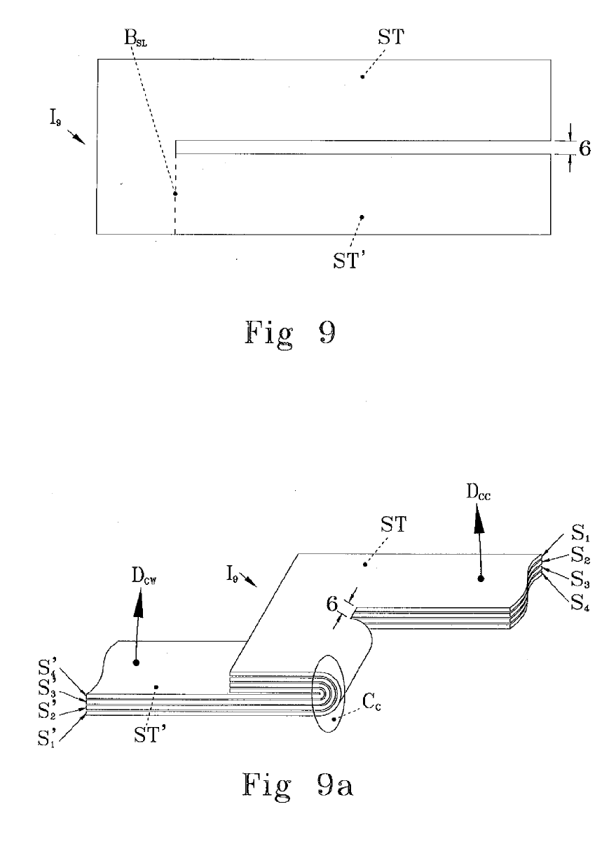

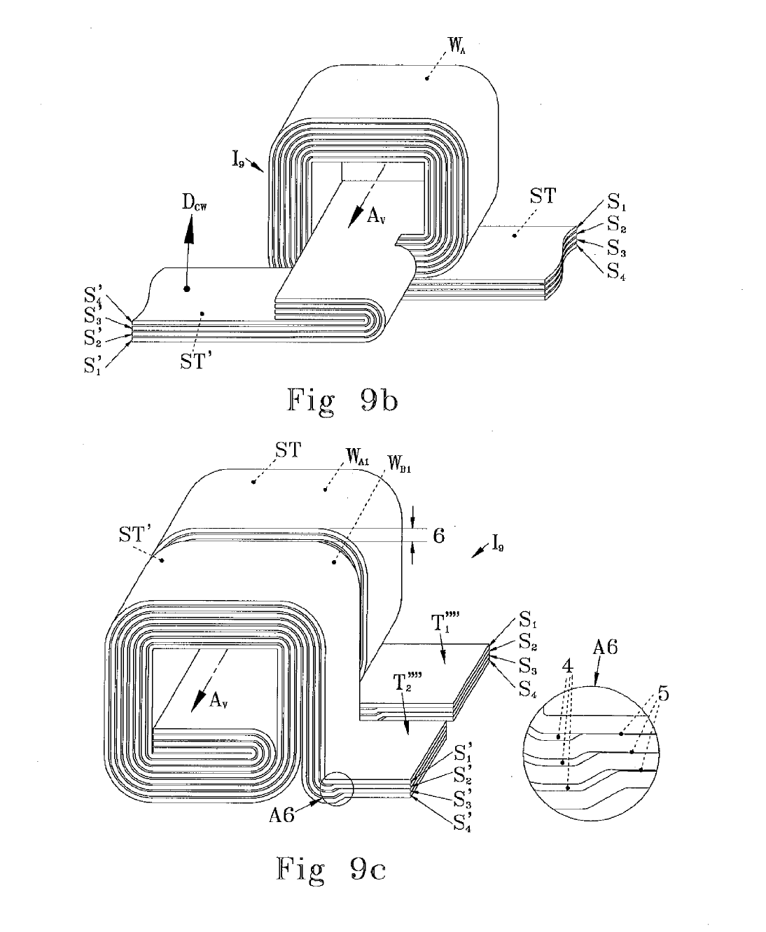

FIG. 9 is a top view of a ninth embodiment of a winding arrangement for inductive components I9 according to the present invention, where a flat band stack ST, ST′ is shown in detail.

The flat band stack ST, ST′ in FIG. 9 is essentially u-shaped. Viewed from the front the left arm of the u-shape will form the first flat band stack ST and the right arm of the u-shape will form the second flat band stack ST′. In this case as well as in FIG. 8 the separation of a first flat band stack ST and a second flat band stack ST′ is only virtual because the u-shaped flat band stack ST, ST′ is arranged as one single geometrically u-shaped flat band stack ST, ST′.

In FIG. 9 the cross connection C_{C} is formed by a connection element of the u-shaped flat band stack ST, ST′ which connects the two arms of the u-shape. Between the right arm of the u-shape and said connection element a straight folding line B_{SL} indicates the section where the right arm of the u-shape has to be bent to form the cross connection C_{C}.

FIG. 9a,b,c are perspective views of the flat band stack ST, ST′ of the ninth embodiment of the winding arrangement for inductive components I9 shown in FIG. 9 in various winding steps

The sequence of the figures demonstrates the sequence of the folding procedure.

The u-shaped flat band stack ST, ST′ of FIG. 9 is shown in FIG. 9a in a perspective side view and comprises four flat band conductors S₁ to S4 on the arm which forms the first flat band stack ST, and four flat band conductors S₁′ to S₄′ on the arm that forms the second flat band stack ST′. In FIG. 9a the arm that forms the second flat band stack ST′ is bent on the folding line B_{SL} of FIG. 9. Furthermore, the first flat band stack ST and the second flat band stack ST′ are arranged at a distance 6 from each other.

The bending that is demonstrated in FIG. 9a forms the cross connection C_{C}. The layer stack sequence is changed by the cross connection C_{C}. Accordingly, the first flat band stack ST and the first flat band conductors are arranged in a sequence of S₁, S₂, S₃, S₄, while the second flat band stack and the second flat band conductors are arranged in an inverted sequence of S₄′, S₃′, S₂′, S₁′.

The first winding W_{A1} is wound in the first winding direction D_{CC} counterclockwise as shown in FIG. 9b. Accordingly the second winding B_{B2} is wound in the second winding direction D_{CW} clockwise as shown in FIG. 9c.

In FIG. 9c in an enlargement A6 it is shown that an isolation 4 is arranged between the single flat band conductors S₁, S₂, S₃, S₄, and S₄′, S₃′, S₂′, S₁′ and that the ends of the flat band conductors S₁, S₂, S₃, S₄, and S₄′, S₃′, S₂′, S₁′ are electrically connected together in taps T₁ and T₂, respectively.

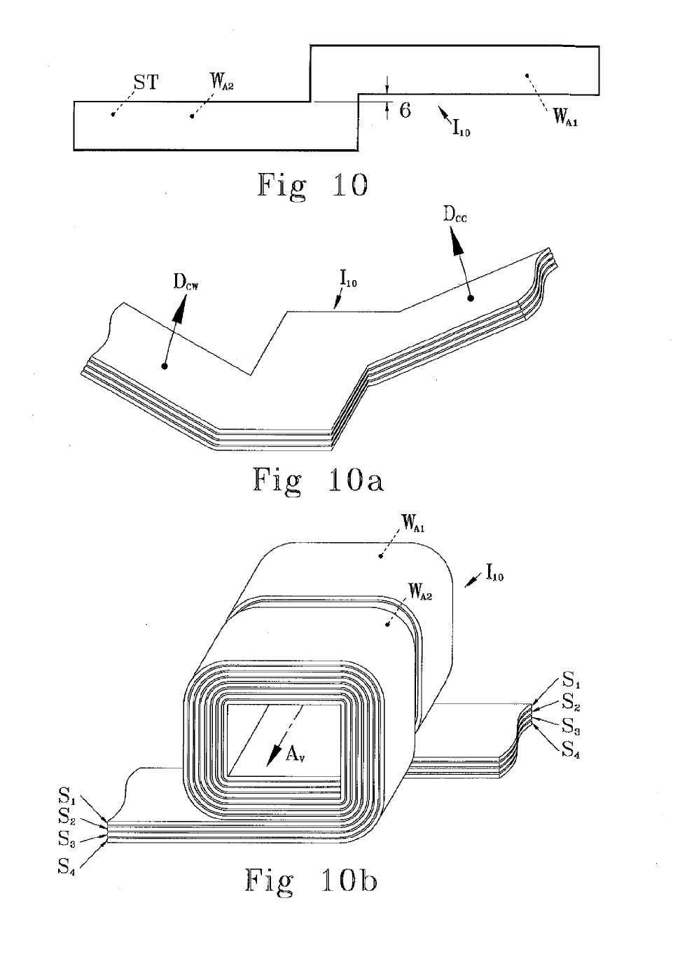

FIG. 10 is a top view of a tenth embodiment of a winding arrangement for inductive components I10 according to the present invention, where a flat band stack is shown in detail.

In FIG. 10 a preferred embodiment of the first windings W_{A1} and W_{A2} is shown having a direct connection C_{D} between individual windings W_{A1} and W_{A2}. The embodiment of FIG. 10 can be used for any direct connection of two first windings W_{A1}-W_{An} or two second windings W_{B1}-W_{Bn}.

The flat band stack ST in FIG. 10 essentially comprises two parallel arms, which are arranged in parallel, the upper arm extending to the right and the lower arm extending to the left. A connection element places the two parallel arms at a distance 6 from each other and electrically connects the single flat band conductors S₁-S₄ to each other.

The upper arm will form the first winding W_{A1} and the lower arm will form the first winding W_{A2}.

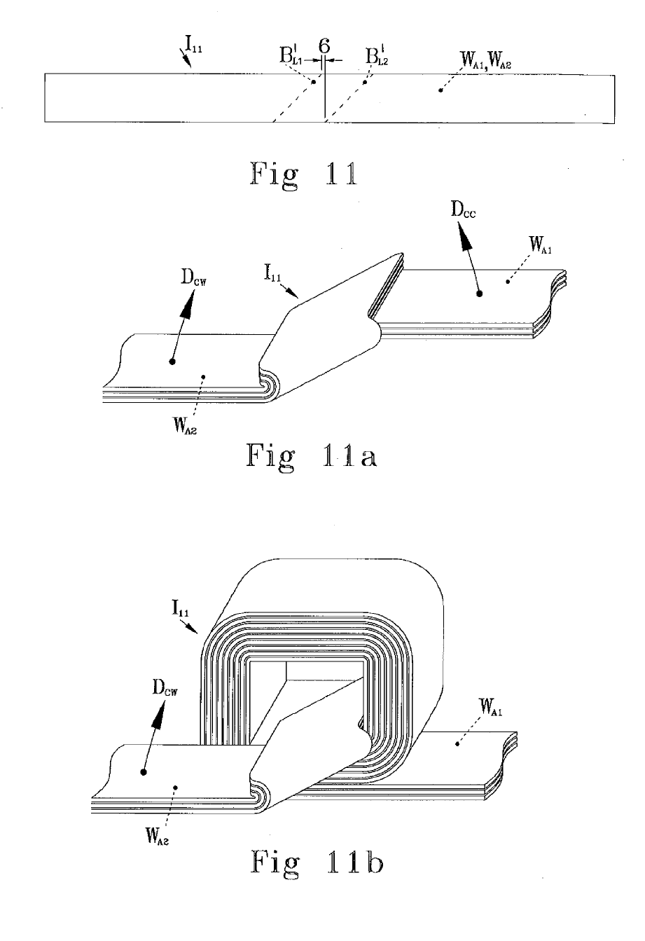

FIG. 10 a,b are perspective views of the flat band stack ST, ST′ of the tenth embodiment I10 shown in FIG. 11 in various winding steps.

FIG. 10a shows the winding directions D_{CW}, D_{CC} of the both individual windings W_{A1} and W_{A2}. The first winding W_{A1} is wound in the first winding direction D_{CC} counter clockwise and the first winding W_{A2} is wound in the second winding direction D_{CW} clockwise.

The preferred embodiment of the first windings W_{A1} and W_{A2} according to FIG. 10b, which does not change the sequence of flat band conductors S₁-S₄ offers a possibility of having both strip ends on the outer side of the first winding section W_{A}. Thus, the said flat band conductors S₁-S₄ can function as one of the taps T₁ and T₂, respectively, and allow further direct connection C_{D} or cross connection C_{C}.

FIG. 11 is a top view of an eleventh embodiment of a winding arrangement for inductive components I11 according to the present invention, where a first winding W_{A1} and a second winding W_{A2} are shown in detail.

The first and second windings W_{A1} and W_{A2} of FIG. 11 extend longitudinally such that the length of the flat band is larger than the width of the flat band that forms the first and second windings W_{A1} and W_{A2}.

Furthermore, the flat band which forms the first and second windings W_{A1} and W_{A2} comprises two folding lines B_{L1}′ and B_{L2}′, where the first folding line B_{L1}′ extends from the center top of the flat band in a 45° angle down to the left and where the second folding line B_{L2}′ extends from the center bottom of the flat band in a 45° angle up to the right. Between the first folding line B_{L1}′ and the second folding line B_{L2}′ a distance 6 can be arranged in one embodiment.

The second preferred embodiment of the winding procedure having a direct connection C_{D} between individual windings W_{A1} and W_{A2} wound out of the straight isolated flat band is demonstrated in FIGS. 11a, 11b and 11c.

FIGS. 11a, 11b, 11c are perspective views of the flat band first and second windings W_{A1} and W_{A2} of the eleventh embodiment of the winding arrangement for inductive components I11 shown in FIG. 11 in various winding steps.

The direct connection C_{D} is performed by two bendings along the folding lines B_{L1} and B_{L2} shown in FIG. 11a. Both sides of the flat band are bent downwards. This results in an arrangement shown in FIG. 11a and sets the ground for winding both individual first windings W_{A1} and W_{A2}, each in an opposite direction.

The FIG. 11b shows wound first winding W_{A1}, while FIG. 11c shows the final arrangement with both first windings W_{A1} and W_{A2}. The said second preferred embodiment having the direct connection C_{D} offers the possibility of having both ends of the flat band first and second windings W_{A1} and W_{A2} on the outer side of the first winding section W_{A}, thus, the said flat band conductors S₁-S₃ function as one of the taps T₁ and T₂ and allow further direct connection C_{D} or cross connection C_{C}.

FIG. 12 is an intersection of a planar version of a twelfth embodiment of a winding arrangement for inductive components I12 according to the present invention.

The winding arrangement for inductive components I12 of FIG. 12 comprises six flat band conductors S₁-S₆. Furthermore, the winding arrangement for inductive components I12 comprises two magnetic cores 1a′″ and 1b′″ which are spaced apart such that the six flat band conductors S₁-S₆ can be passed between the two magnetic cores 1a′″ and 1b′″.

The winding arrangement for inductive components I12 comprises a first winding W_{A}′″ which is formed of six flat band conductors S₁-S₆ which are wound around the first magnetic core 1a′″ and passed in between the two magnetic cores 1a′″ and 1b′″ to be wound around the second magnetic core 1b′″, forming a second winding W_{B}′″. The ends of the six flat band conductors S₁-S₆ are electrically connected together to form a first tap T₁ on one end and a second tap T₂ on the other end.

In FIG. 12 it becomes apparent, that the cross connection C_{C} is not formed explicitly by discrete wiring or folding, but, the cross connection C_{C} is formed implicitly between the two magnetic cores 1a′″ and 1b′″ and the s-shaped winding of the six flat band conductors S₁-S₆ around the two magnetic cores 1a′″ and 1b′″. In FIG. 12 it, furthermore, becomes apparent that the first winding WA′″ and the second winding WB′″ are wound in contrary directions with respect to the virtual Axis A_{V}′ in order to change the layer sequence.

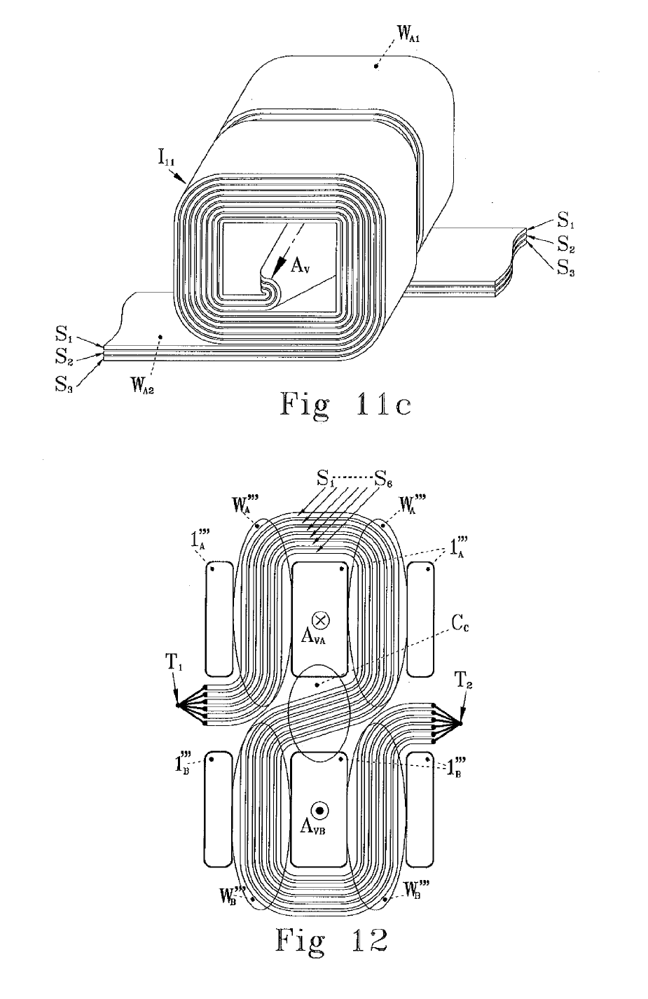

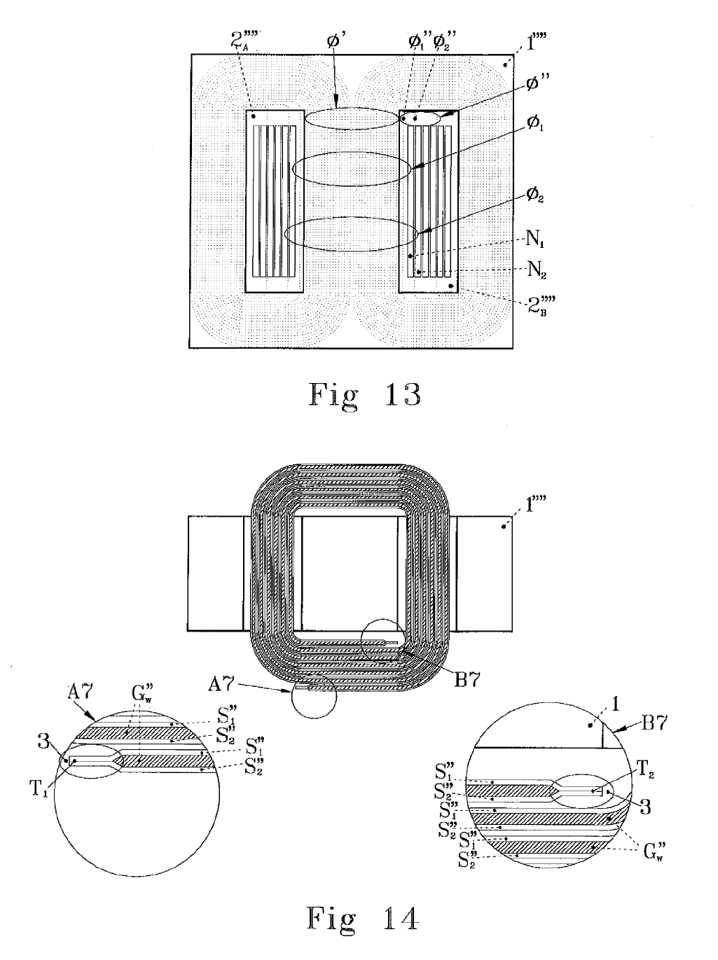

FIG. 13 shows a vertical cross section of an inductive component in order to demonstrate flux lines.

In FIG. 13 reference sign 1″″ denotes the magnetic core and the reference signs 2a″″, 2b″″ denote a winding window area. The flux lines Φ are divided into core flux lines Φ′={Φ₁′ . . . Φₙ′}; nε [symbol] and the undesired stressed flux φ″={Φ₁″ . . . Φₙ″}; nε [symbol] .

Each turn N1, N2 starting from the inside to the outside includes more flux lines, such that the turn N₁ includes Φ₁ flux lines, which consists of the core flux Φ′ and Φ₁″ and the turn N₂ includes Φ₂ flux lines consisting of the core flux Φ′ plus Φ₁″ and Φ₂″.

FIG. 14 shows a horizontal cross section of an inductive component of FIG. 13.

In FIG. 14 the inductive component comprises a winding which is made out of two insulated parallel flat strips S₁″ and S₂″ surrounding gap G_{W}″. The strips S₁″ and S₂″ are connected on both ends in a respective connecting area 3 into taps T₁ and T₂. The conductive flat strips S₁ and S₂ form a single flat band conductor. Enlargements A7 and B7 show the arrangement of the flat strips S₁ and S₂ and the taps T₁ and T₂.

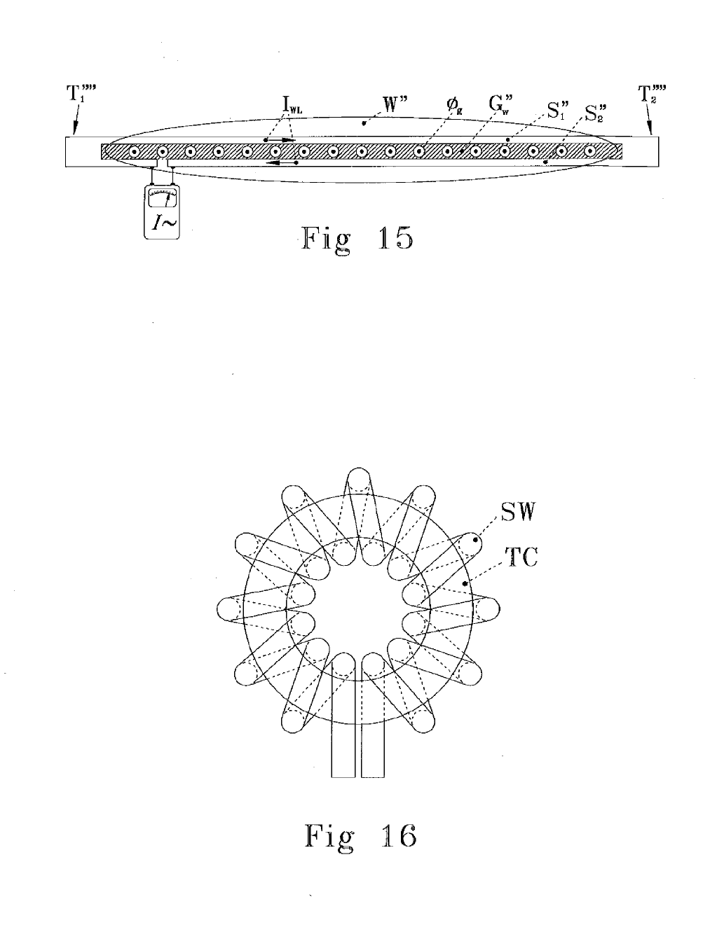

The winding gap flux Φ_{g} as a part of stressed flux φ″ of FIG. 13 flows through the winding gap G_{W} of a stretched conductor. This is shown in FIG. 15.

FIG. 15 is a stretched conductor of an inductive component of FIG. 13.

In FIG. 15 the conductor comprises two flat band conductors S₁″ and S₂″ which are separated by gap G_{W}″. On the ends the flat band conductors S₁″ and S₂″ are electrically connected in a first tap T₁″″ and a second Tap T₂″″ respectively.

The winding gap flux Φ_{g} is causing the longitudinal equalizing current I_{WL} along the whole length of the stretched conductor, which represents the winding W of the inductive component.

FIG. 16 shows a common inductor comprising litz wire SW around a toroid core TC.

Although specific embodiments have been illustrated and described herein, it will be appreciated by those of ordinary skill in the art that a variety of alternate and/or equivalent implementations exist. It should be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

In the foregoing detailed description, various features are grouped together in one or more examples or examples for the purpose of streamlining the disclosure. It is understood that the above description is intended to be illustrative, and not restrictive. It is intended to cover all alternatives, modifications and equivalents as may be included within the scope of the invention. Many other examples will be apparent to one skilled in the art upon reviewing the above specification,

Specific nomenclature used in the foregoing specification is used to provide a thorough understanding of the invention. However, it will be apparent to one skilled in the art in light of the specification provided herein that the specific details are not required in order to practice the invention. Thus, the foregoing descriptions of specific embodiments of the present invention are presented for purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Throughout the specification, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on or to establish a certain ranking of importance of their objects.

### REFERENCE SIGNS

I1-I12 winding arrangement for inductive components
W_{A}; W_{A}′; W_{A}″; W_{A}′″ first winding section
W_{B}; W_{B}′; W_{B}″; W_{B}′″ second winding section
W_{A1}-W_{An}; W_{A1}′-W_{An}′; W_{A1}″-W_{An}″ first winding
W_{B1}-W_{Bn}; W_{B1}′-W_{Bn}′; W_{B1}″-W_{Bn}″ second winding
S₁-S₆; S₁′-S₅′ flat band conductors
ST first flat band stack
ST′ second flat band stack
D_{CC} first winding direction
D_{CW} second winding direction
C_{C}, C_{C1}-C_{C2}; C_{C}, C_{C1}-C_{C5} cross connection
C_{D}, C_{D1}-C_{D2}; C_{D}, C_{D1}-C_{D5} direct connection
T1, T2; T1′, T2′; T1″, T2″ electric tap
A_{V}, A_{V}′ virtual axis
G_{W}″ gap
1; 1′; 1″, 1a′″, 1b′″ magnetic core
2; 2a′, 2b′; 2a″, 2b″ winding window
4 isolator
5 electrical connection
6 distance
A-A7, B-B7 enlargement

1. A winding arrangement for inductive components, comprising:
a first winding section comprising at least one first winding, the at least one first winding comprising at least two electrically isolated parallel flat band conductors being configured as a first flat band stack;
a second winding section comprising at least one second winding, the at least one second winding comprising at least two electrically isolated parallel flat band conductors being configured as a second flat band stack;
wherein first ends of the flat band conductors of the first winding section are cross connected in a cross connection to first ends of the flat band conductors of the second winding section such that a first current flow stacking sequence in the first flat band stack is reversed to a second current flow stacking sequence in the second flat band stack;
wherein second ends of the flat band conductors of the first winding section are at least electrically connected in a first electric tap; and
wherein second ends of the flat band conductors of the second winding section are at least electrically connected in a second electric tap.

2. The winding arrangement for inductive components according to claim 1, wherein:
at least one first winding is wound in a first winding direction with regard to a virtual axis of the winding arrangement for inductive components, and
the at least one second winding is wound in a second winding direction being opposite to the first winding direction (D_{CC}) with regard to the virtual axis of the winding arrangement for inductive components.

3. The winding arrangement for inductive components according to claim 1, further comprising:
at least one first winding wound on a first magnetic core; and
at least one second winding wound around a second magnetic core.

4. The winding arrangement for inductive components according to claim 3, wherein:
the stacking sequence is reversed through the at least one first winding, and
the at least one second winding is wound around the first magnetic core and the second magnetic core, respectively, in an s-shaped arrangement.

5. The winding arrangement for inductive components according to claim 1, further comprising:
a magnetic core, the at least one first winding being wound around the core in the first winding direction and the at least one second winding being wound around the core in the second winding direction.

6. The winding arrangement for inductive components according to claim 1, wherein the first winding section and the second winding section are configured essentially symmetrical.

7. The winding arrangement for inductive components according to claim 1, wherein:
the first winding section comprises a plurality of first windings,
the electrical conductors of the at least two first windings are connected electrically in series in a direct connection, and
the at least two first windings are wound in alternating directions.

8. The winding arrangement for inductive components according to claim 1, wherein:
the second winding section comprises a plurality of second windings,
the electrical conductors of the at least two second windings are connected electrically in series in a direct connection, and
the at least two second windings are wound in alternating directions.

9. The winding arrangement for inductive components according to claim 1, wherein the cross connection is arranged at the innermost loop of the at least one first winding and the at least one second winding.

10. The winding arrangement for inductive components according to claim 1, wherein the cross connection is arranged at the outermost loop of the at least one first winding and the at least one second winding.

11. The winding arrangement for inductive components according to claim 1, wherein the cross connection is implemented by an electric wiring arrangement.

12. The winding arrangement for inductive components according to claim 1, wherein the cross connection is implemented by a folding arrangement of the at least one first winding section and/or the at least one second winding section.

13. The winding arrangement for inductive components according to claim 12, wherein the first winding section and the second winding section with the cross connection in between are implemented by a folding arrangement of one single longitudinal flat band stack.

14. The winding arrangement for inductive components according to claim 12, wherein:
the first winding section and the second winding section with the cross connection in between are implemented by a folding arrangement of one u-shaped flat band stack;
the first winding section is formed by a first arm of the u-shaped flat band stack;
the second winding section is formed by a second arm of the u-shaped flat band stack; and
the cross section is formed by a connection element of the u-shaped flat band stack, which connection element connects the first arm and the second arm of the u-shaped flat band stack.

15. (canceled)

16. A method for manufacturing a winding arrangement for inductive components, comprising:
providing a first winding section comprising at least one first winding, the at least one first winding comprising at least two electrically isolated parallel flat band conductors, the first winding being configured as a first flat band stack;
providing a second winding section comprising at least one second winding, the at least one second winding comprising at least two electrically isolated parallel flat band conductors, the second winding being configured as a second flat band stack;
winding the at least one first winding in a first winding direction with regard to a virtual axis of the winding arrangement for inductive components;
winding the at least one second winding in a second winding direction opposite to the first winding direction with regard to the virtual axis of the winding arrangement for inductive components; and
cross connecting the flat band conductors of the first winding section to the flat band conductors of the second winding section such that a first current flow stacking sequence in the first flat band stack is reversed to a second current flow stacking sequence in the second flat band stack;
connecting second ends of the flat band conductors of the first winding section at least electrically in a first electric tap; and
connecting second ends of the flat band conductors of the second winding section at least electrically in a second electric tap.

17. The winding arrangement for inductive components according to claim 1, wherein the winding arrangement is included in a transformer.

18. The winding arrangement for inductive components according to claim 5, wherein the cross connection is arranged at the innermost loop of the at least one first winding and the at least one second winding.

19. The winding arrangement for inductive components according to claim 5, wherein the cross connection is arranged at the outermost loop of the at least one first winding and the at least one second winding.

20. The winding arrangement for inductive components according to claim 7, wherein the cross connection is arranged at the innermost loop of the at least one first winding and the at least one second winding.

21. The winding arrangement for inductive components according to claim 7, wherein the cross connection is arranged at the outermost loop of the at least one first winding and the at least one second winding.
